(19) United States
(12) Patent Application Publication
(10) Pub. No.: US 2005/0003050 A1
(43) Pub. Date: Jan. 6, 2005

(54) Animal chew product with multiple dental hygiene benefits

(76) Inventor: Beverly R. Agnew, Tucson, AZ (US)

Correspondence Address: QUARLES & BRADY STREICH LANG, LLP, ONE SOUTH CHURCH AVENUE, SUITE 1700, TUCSON, AZ, 85701-1621, US

(21) Appl. No.: 10/613,671

(22) Filed: Jul. 3, 2003

(51) Int. Cl. A23G 1/00

(52) U.S. Cl. 426/132

(57) ABSTRACT

A fabric sleeve having an edible product at least partially disposed therein. The sleeve provides a plurality of openings through which an animal chews the interior contents, thereby scaling and flossing its teeth and massaging its gums on the sleeve openings and edible treat. Because the animal must access the edible product through the sleeve openings, the contact time with the edible product is increased and the beneficial effect of any medicinal agent are enhanced. Moreover, the sleeve may treated with a medicinal agent and may be made easily re-loadable through a re-sealable closure disposed along an edge of the sleeve. Thus, multiple dental hygiene benefits are achieve in a single animal chew article.

### BACKGROUND

1. Field of the Invention

The invention relates in general to the field of chew articles for pets and more particularly to an article having at least one edible product that is substantially enveloped by a fabric sleeve, with the sleeve possessing a plurality of openings through which an animal chews the object.

2. Description of the Related Art

A large variety of animal chew articles exist that promote teeth cleaning and other oral hygiene benefits. Some articles consist simply of hard, edible substances, such as dog biscuits or “nylon bones,” that gradually break apart or degrade as the article is chewed. The dental benefits provided by such articles are primarily limited to “scaling” (i.e., tooth enamel scraping). Thus, the animal's teeth are cleaned as the product is consumed.

Other articles, such as various plastic and hard rubber toys, are not truly edible as they are not meant to be consumed. Instead, these items typically provide a textured surface that massages the animal's gums and, depending on the hardness of the item, also scales the teeth. For example, U.S. Pat. No. 6,439,166 issued to Markham discloses an animal toy with raised features. Markham's toy preferably is made from a resilient flexible material and can include a hollow core that houses animal treats to encourage chewing on the toy. However, the animal's teeth do not directly contact the treat unless it is emptied from the hollow core. Also, once the treat has been emptied, the animal may immediately lose interest in cleaning its teeth on the toy, opting instead to simply chew up the treat.

Still other chew articles are designed to provide a flossing effect. Thus, “rope bones” (cordage or fibers formed into cylindrical shapes) are given to animals so that areas between the teeth can be cleaned as the “bone” is chewed and disintegrates into individual threads or fibers. However, this type of chew article may not scale teeth as effectively as harder products. Moreover, rope bones can not easily be loaded with a treat, making them less appealing to some animals. Furthermore, most rope bones are not washable and harbor bacteria. Therefore, these articles must be discarded when they become too dirty, smelly, or unhygienic to use indoors.

Numerous treats containing medicinal or otherwise active agents or ingredients (e.g., fluoride, chlorophyll, urea, thymol, golden seal, and the like) are available to reduce plaque, calculus, and bad breath. However, because these treats are designed to be both digestible and appetizing, an animal will typically devour the product quickly. Thus, the treat is broken down and ingested before the full potential benefit can be realized.

In view of the above, it would be desirable to have a chew article that simultaneously provides tooth scaling, gum massage, and a flossing effect, is re-loadable with practically any solid treat, is washable, safe to digest, durable, and will allow existing medicinal treats to be used with greater effectiveness by increasing contact time with the beneficial ingredients.

### SUMMARY OF THE INVENTION

The invention relates in general to a fabric sleeve that surrounds an edible animal treat. More particularly, the invention provides a re-loadable fabric sleeve having a plurality of openings through which an animal chews the interior treat, thereby scaling its teeth on the edible treat and flossing its teeth and massaging its gums on the sleeve openings. Furthermore, the beneficial effects of medicinal treats are increased because contact time with an animal's oral tissues is augmented. Moreover, the sleeve itself can be treated with a medicinal agent, thereby providing an additional delivery method as the animal chews. Thus, multiple dental hygiene benefits are achieved in a single animal chew article.

Preferably, the fabric sleeve of the invention is composed of strips of natural fibers (e.g., cotton) that form a “cris-cross pattern” with openings large enough to allow an animal's teeth to access the edible product through the sleeve and to allow pieces of the edible product contained within to come out while the animal is chewing the sleeve. Also preferably, a rope bone is included within the sleeve (in addition to another edible product) to enhance the flossing and gum messaging effects of the fabric sleeve. Furthermore, although the fabric sleeve can be permanently sewn shut around the edible product(s), preferably at least one portion of the sleeve may be opened and closed (such as with hook and loop fasteners), thereby making the sleeve easily re-loadable.

Moreover, the invention is meant to be an integral part of an animal mouth care system that maximizes the benefits of cavity and plaque control biscuits. Because medicinal agents are added to many pet treat or biscuit-type products to combat tooth decay and periodontal disease, the sleeve of the invention enhances the action of such products by allowing prolonged exposure of the medicinal agent(s) to the teeth and tissues of the mouth. This occurs because the animal must get its teeth through the sleeve openings in order to contact the edible product, break the product apart, and slowly eat the broken pieces that eventually exit through the sleeve openings. Preferably, the sleeve openings are between one-quarter inch to one inch in diameter.

The “prolonged exposure” effect may be further enhanced by adding a “rope bone” or other non-food item to the sleeve in combination with another edible product so the animal must work through multiple “impediments” in order to access the more desirable product. Also, the fabric sleeve itself may be treated with a medicinal agent so that direct contact with the animal's oral tissues and saliva provides a beneficial effect.

Thus, it is a primary objective of the invention to provide an animal chew article with multiple dental hygiene benefits.

Further, an object of the invention is to provide an animal chew article that is re-loadable with a new edible treat such that an animal's interest in the article remains piqued.

Another object of the invention is to provide a single animal chew article that encourages an animal to simultaneously scale and floss its teeth and message its gums.

Still another object of the invention is to provide an animal chew article that is durable and re-useable.

Further, an object of the invention is to provide an animal chew article the slows the consumption of a medicinal agent so that the beneficial effects of the agent on the animal's oral tissues are more fully realized.

Yet another object of the invention is to provide an animal chew article that is washable.

Still another object of the invention is to provide an animal chew article that is simple and inexpensive to manufacture.

In accordance with these and other objects there is provided a new and improved animal chew article featuring a fabric sleeve having a plurality of openings through which the animal chews an edible product placed inside the sleeve.

Various other purposes and advantages of the invention will become clear from its description in the specification that follows. Therefore, to the accomplishment of the objectives described above, this invention includes the features hereinafter fully described in the detailed description of the preferred embodiments, and particularly pointed out in the claims. However, such description discloses only some of the various ways in which the invention may be practiced.

### BRIEF DESCRIPTION OF THE DRAWINGS

FIG. 1A is a schematic, front elevational view of a first embodiment of the invention.

FIG. 1B is a cross-sectional view of the embodiment shown in FIG. 1A as taken along line 1B-1B.

FIG. 2 is a schematic, front elevational view of a preferred embodiment.

FIG. 3A is a schematic, front elevational view of a third embodiment of the invention shown in an open state (before a treated is enclosed).

FIG. 3B is a schematic, front perspective view of the embodiment of FIG. 3A shown in a closed state (i.e., enclosing most of an edible treat).

### DETAILED DESCRIPTION OF THE PREFERRED EMBODIMENTS

The invention involves a fabric sleeve that encloses one or more edible products or treats. The animal chews through openings in the sleeve to break-up the edible product, thereby scaling and flossing its teeth and messaging its gums in the process. Furthermore, the contact time the animal has with one or more medicinal agents contained in the edible product or disposed on a non-food item (and/or on the fabric sleeve itself) is increased. Preferably, the sleeve of the invention is made from compacted natural fibers and contains at least one solid edible treat in combination with a non-food item, such as a rope bone.

The fabric sleeve of the invention is more versatile than existing dental hygiene products because it can accommodate practically and size or shape edible product. Moreover, the invention enhances the effectiveness of existing products by partially impeding an animal's access to an edible item(s) disposed therein, thereby causing the animal to chew and maintain contact with the scaling, flossing, or medicating surface longer.

As used throughout this application, the terms “edible product,” “edible treat,” or “treat” are all meant to broadly describe any edible solid substance given to animals to encourage chewing thereon. Such substances may include, but are not limited to, dog biscuits, hooves, nylon bones, rawhide chews, rope bones, and the like. Moreover, the term “non-food item” is meant to broadly describe any item that, while edible, provides no caloric value. Such items may include, but are not limited to, rope bones, nylon bones, and the like. Both edible products and non-food items can be flavored, scented, or treated with a medicinal agent to provide additional benefits to the animal.

The term “medicinal agent” is meant to broadly describe any chemical substance that provides a beneficial effect upon chewing or consumption by an animal. Thus, a medicinal agent may include, but is not limited to, vitamins, minerals, fluoride, chlorophyll, urea, thymol, golden seal, peroxide, salivary enzymes, and the like.

The term “fabric” is meant to broadly describe cloth, especially one made by knitting, weaving, or felting fibers. This fabric may be manufactured with openings being perforated or otherwise formed. Moreover, the fabric sleeve may be woven together or formed with twisted strands of material or strips of material in a crisscross pattern. However, as would be recognized by one skilled in the art, the production of fabric is not limited to the use of natural fibers. In other words, synthetic fibers or materials, such as nylon and polyester, may be used to produce fabric. Accordingly, the invention is not to be limited to a particular fabric, but, instead, may include either (or both) natural and synthetic fibers and materials.

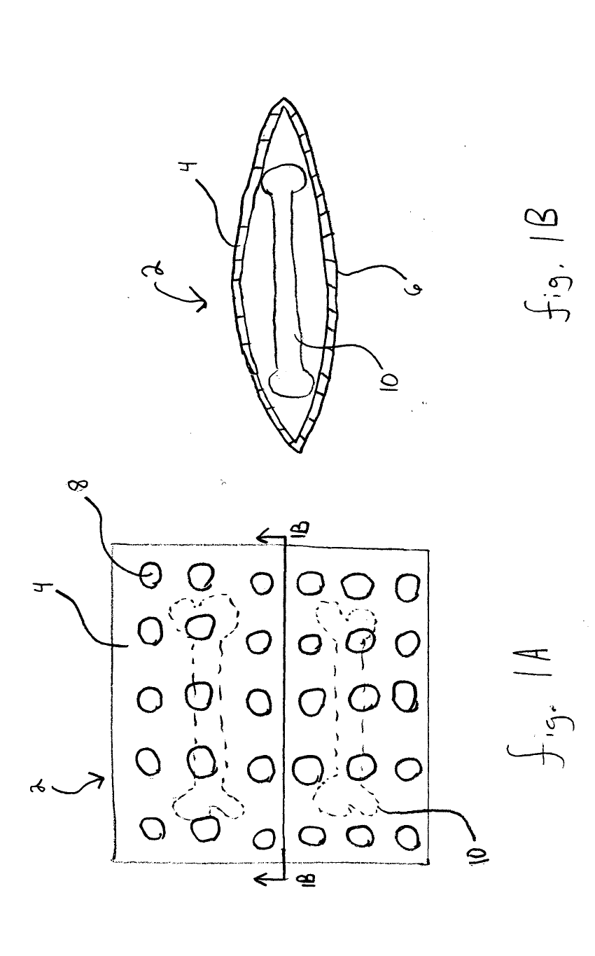

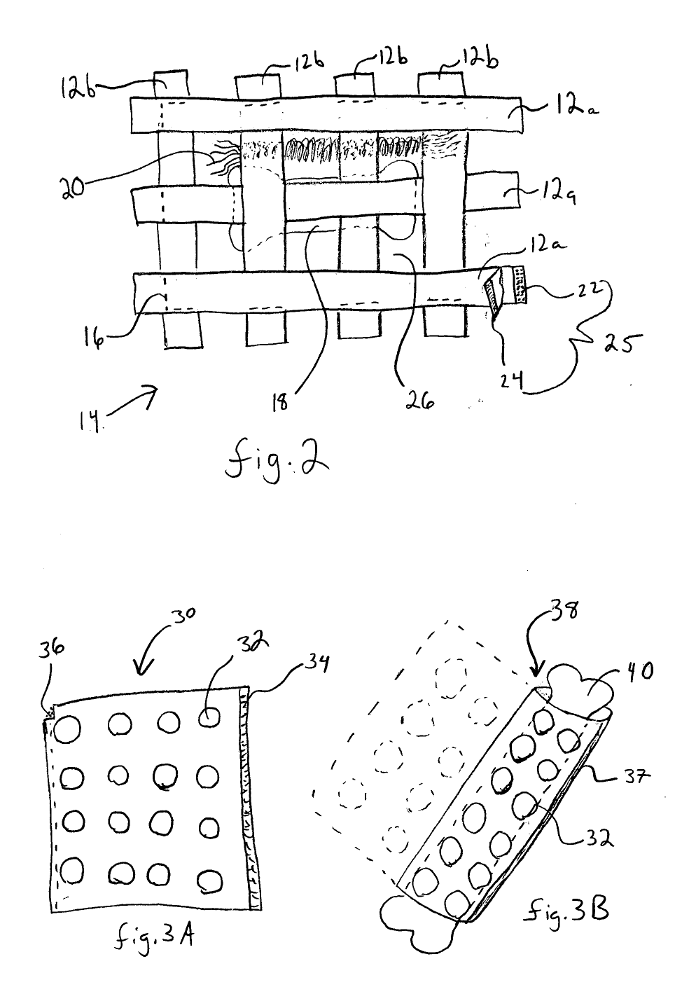

Turning to FIG. 1A and 1B, a schematic, front elevational view of an embodiment of the invention is shown. The fabric sleeve 2 includes a front panel 4, a back panel 6 (see FIG. 1B), and a plurality of openings 8 disposed within the front and back of sleeve 2. Contained within the sleeve 2 are edible products 10. By chewing through the openings 8 in sleeve 2, an animal breaks-up the products 10, thereby scaling the teeth, massaging the gums, and providing a flossing effect as the fabric sleeve 2 goes between the teeth. FIG. I B shows a cross-sectional view of the sleeve 2 as taken along line 1B-1B in FIG. 1A. As seen in this particular embodiment, the sleeve 2 may include two pieces of fabric (i.e., front 4 and back 6) that are fastened together. However, the sleeve 2 may instead comprise a single sheet of fabric that is folded over and fastened (e.g., sewn) around the edible product(s) 10. Moreover, preferably, at least one edge of sleeve 2 has a re-sealable closure means, such as would be formed by hook and loop fasteners (see FIG. 2). Thus, the sleeve 2 can be made re-loadable to ensure continued interest by the animal (as well as to provide a variety of different treats should one not be sufficiently appealing to the animal).

Turning to FIG. 2, a preferred embodiment of the invention is shown in front elevational view. Here, fabric strips 12a and 12b are fastened together to form a cris-cross pattern sleeve 14. Preferably, the fabric strips 12a and 12b comprise durable natural-fiber straps. In this embodiment, the sleeve 14 is formed by stitching 16 straps 12a and 12b along the perimeter as shown. Thus, edible products 18 (a dog biscuit) and 20 (a rope bone) are securely enclosed on three sides. On the fourth side, hook means 22 and loop means 24 form a re-sealable closure means 25 on one end of each strip 12a.

Of course, if the openings 26 in the sleeve 14 are large enough, a new treat may simply be pushed through an opening 26 without the need for a re-sealable closure means. Furthermore, while the size of openings 26 can be varied, common sense dictates that they must be (1) large enough to allow teeth in and small pieces of edible treat out but (2) not so large that an intact (or large chunks of) edible product readily comes out. Therefore, the preferred size of openings is between one-quarter inch to one inch in diameter.

As shown in FIGS. 3A and 3B, the invention may include a single fabric sheet 30 containing a plurality of openings 32. Along one edge of the sheet a fastening system may be disposed (e.g., a VELCRO hook and loop fastener). Thus, on one edge a hook fastener 34 is attached to sheet 30 while a loop fastener 36 is disposed upon the underside of an opposite edge as shown. Thus, as seen in FIG. 3B, the hook 34 and loop 36 fasteners may be joined to form a re-sealable closure means 37 that forms a sleeve 38 around most of an edible treat 40.

Because the sleeve of the invention is made of fabric, it is simple and inexpensive to produce as it requires no molding or other specialized manufacturing. In addition, the sleeve of the invention may be washed when dirty or order-laden. Accordingly, the consumer is provided a chew article for an animal that is versatile and re-usable yet inexpensive to replace when needed.

The sleeve of the invention may also be provided in a method to assist in dispensing medicinal agents and enhancing their effects. The method may involve simply treating the sleeve with one or more medicinal agents (e.g., flouride) and then allowing an animal to chew the sleeve. To maximize the effectiveness of existing oral care products, one or more edible products containing a (or several) medicinal agent may be enclosed by the sleeve. Thus, edible products that help scale teeth or fight tooth decay and periodontal disease are provided within the sleeve such that they cannot be quickly chewed and swallowed before they are effective.

Various changes in the details and components that have been described may be made by those skilled in the art within the principles and scope of the invention herein described in the specification and defined in the appended claims. Therefore, while the present invention has been shown and described herein in what is believed to be the most practical and preferred embodiments, it is recognized that departures can be made therefrom within the scope of the invention, which is not to be limited to the details disclosed herein but is to be accorded the fill scope of the claims so as to embrace any and all equivalent processes and products.

1. A chew article for animals, comprising:
a fabric sleeve having a plurality of openings, and
a solid edible product at least partially enclosed within said fabric sleeve.

2. The article of claim 1, wherein said fabric sleeve comprises a natural-fiber material.

3. The article of claim 2, wherein said fabric sleeve comprises cotton.

4. The article of claim 1, wherein said article includes in combination said edible product and a cordage member.

5. The article of claim 1, wherein said article further includes a re-sealable closure means disposed along an edge of said fabric sleeve.

6. The article of claim 4, wherein said article further includes re-sealable closure means disposed along an edge of said fabric sleeve.

7. The article of claim 1, wherein said fabric sleeve comprises fabric strips arrayed in a crisscross pattern.

8. The article of claim 4, wherein said fabric sleeve comprise fabric strips arrayed in a crisscross pattern.

9. The article of claim 6, wherein said fabric sleeve comprises fabric strips arrayed in a cris-cross pattern.

10. The article of claim 1, wherein said plurality of openings are between one-quarter inch to one inch in diameter.

11. The article of claim 1, wherein said sleeve is treated with a medicinal agent.

12. The article of claim 1 1, wherein said medicinal agent is selected from the oral care ingredient group consisting of vitamins, minerals, fluoride, chlorophyll, urea, thymol, golden seal, peroxide, and salivary enzymes.

13. A method for administering a medicinal agent to an animal, comprising the steps of:
(a) providing a fabric sleeve having a plurality of openings,
(b) treating said fabric sleeve with one or more medicinal agents; and
(c) giving said fabric sleeve of step (b) to said animal to chew.

14. The method of claim 13, further comprising the step of:
at least partially enclosing a solid edible product within said fabric sleeve prior to step (c).

15. The method of claim 14, wherein an additional edible product is enclosed within said edible product.

16. The method of claim 15, wherein said additional edible product comprises a cordage member.
